(19) United States
(12) Patent Application Publication
(10) Pub. No.: US 2025/0096368 A1
(43) Pub. Date: Mar. 20, 2025

(54) EXPANDABLE ENCLOSURES FOR PRISMATIC AND CYLINDRICAL BATTERY CELLS

(71) Applicant: GM GLOBAL TECHNOLOGY OPERATIONS LLC, Detriot, MI (US)

(72) Inventors: Lu HUANG, Troy, MI (US); Blair E. Carlson, Ann Arbor, MI (US); Charles W. Wampler, II, Birmingham, MI (US); Jing Gao, Rochester, MI (US); Brian J. Koch, Berkley, MI (US); Margaux Elise LeBlanc, West Bloomfield, MI (US); Jeffrey A. Abell, Rochester, MI (US)

(21) Appl. No.: 18/470,813

(22) Filed: Sep. 20, 2023

(51) Int. Cl. H01M 50/103; H01M 50/107; H01M 50/133; H01M 50/134; H01M 50/136

(52) U.S. Cl. CPC H01M 50/103; H01M 50/107; H01M 50/133; H01M 50/134; H01M 50/136

(57) ABSTRACT

An enclosure for a prismatic battery cell include first side surfaces, second side surfaces connected between the first side surfaces, a top surface connected between the first side surfaces and the second side surfaces, and a bottom surface connected between the first side surfaces and the second side surfaces. The first side surfaces, the second side surfaces, the top surface and the bottom surface are configured to receive a battery cell stack. The second side surfaces, the top surface and the bottom surface expand/contract to allow guided expansion/contraction of the enclosure in a first direction while limiting expansion in second and third directions transverse to the first direction.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to an enclosure for prismatic battery cells and cylindrical battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

An enclosure for a prismatic battery cell include first side surfaces, second side surfaces connected between the first side surfaces, a top surface connected between the first side surfaces and the second side surfaces, and a bottom surface connected between the first side surfaces and the second side surfaces. The first side surfaces, the second side surfaces, the top surface and the bottom surface are configured to receive a battery cell stack. The second side surfaces, the top surface and the bottom surface expand/contract to allow guided expansion/contraction of the enclosure in a first direction while limiting expansion in second and third directions transverse to the first direction.

In other features, the second side surfaces, the top surface, and the bottom surface comprise corrugations. The second side surfaces, the top surface, and the bottom surface of the enclosure are made of a first material that is less stiff than a second material of the first side surfaces. The second side surfaces, the top surface, and the bottom surface of the enclosure are made of a first material having a first thickness, wherein the first side surfaces are made of the first material and have a second thickness greater than the first thickness.

In other features, the second side surfaces, the top surface, and the bottom surface comprise first portions and second portions. The first portions are one of hardened and softened relative to the second portions. The first portions of the second side surfaces, the top surface, and the bottom surface are one of hardened and softened using at least one of laser and infrared heating.

In other features, the first portions of the second side surfaces, the top surface, and the bottom surface are softened using ultrasonic vibration. The first side surfaces are curved one of inwardly and outwardly. The second side surfaces, the top surface, and the bottom surface comprise groove portions and non-grooved portions, wherein the grooved portions are thinner than the non-grooved portions. One or more strengthening beads are arranged on the first side surfaces.

In other features, an offset surface arranged on the first side surfaces, wherein the offset surface comprises more than 50% of an area of the first side surfaces. An offset surface is arranged on the first side surfaces. The offset surface comprises more than 50% of an area of the first side surfaces.

An enclosure for a prismatic battery cell includes first side surfaces, second side surfaces connected between the first side surfaces, a top surface connected between the first side surfaces and the second side surfaces, and a bottom surface connected between the first side surfaces and the second side surfaces. The enclosure is configured to receive a battery cell stack. The first side surfaces include at least one of a plurality of stiffening beads and an offset surface comprising greater than 50% of an area of the first side surfaces. The second side surfaces, the top surface and the bottom surface expand to allow guided expansion/contraction of the enclosure in a first direction while limiting expansion in second and third directions transverse to the first direction.

In other features, the second side surfaces, the top surface, and the bottom surface comprise corrugations. The second side surfaces, the top surface, and the bottom surface of the enclosure are made of a first material that is less stiff than a second material of the first side surfaces. The second side surfaces, the top surface, and the bottom surface of the enclosure are made of a first material having a first thickness, wherein the first side surfaces are made of the first material and have a second thickness greater than the first thickness.

In other features, the second side surfaces, the top surface, and the bottom surface comprise first portions and second portions. The first portions are one of hardened and softened relative to the second portions using at least one of laser heating, infrared heating, and ultrasonic vibration.

In other features, the first side surfaces are curved one of inwardly and outwardly. The second side surfaces, the top surface, and the bottom surface comprise groove portions and non-grooved portions, wherein the grooved portions are thinner than the non-grooved portions.

In other features, one or more strengthening beads are arranged on the first side surfaces.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes, and separators arranged in a battery cell enclosure according to the present disclosure;

FIGS. 2A to 2C are perspective and cross sectional views illustrating an example of an enclosure for a prismatic battery cell with corrugated side surfaces according to the present disclosure;

FIGS. 3A to 3C are perspective and cross sectional views illustrating an example of an enclosure for a prismatic battery cell with grooved side surfaces according to the present disclosure;

FIGS. 4A to 4C are perspective and cross sectional views illustrating an example of an enclosure for a prismatic battery cell with laser softened and/or hardened side surfaces according to the present disclosure;

FIGS. 5A to 5C are perspective and cross sectional views illustrating an example of an enclosure for a prismatic battery cell with weakened side surfaces according to the present disclosure;

FIGS. 6A to 6C are perspective and cross sectional views illustrating an example of an enclosure for a prismatic battery cell with softened edges and/or corners according to the present disclosure;

FIGS. 7A to 7C are perspective and cross sectional views illustrating an example of an enclosure for a prismatic battery cell with convex or inwardly curved side surfaces according to the present disclosure;

FIGS. 8A to 8C are perspective and cross sectional views illustrating an example of an enclosure for a prismatic battery cell with offset side surfaces according to the present disclosure;

FIGS. 9A to 9C are perspective and cross sectional views illustrating an example of an enclosure for a prismatic battery cell with stiffening beads according to the present disclosure; and

FIG. 10 is a perspective view illustrating an example of an enclosure for a cylindrical battery cell with sides and/or top surface including stiffening beads according to the present disclosure.

In the drawings, reference numbers may be reused to identify similar and/or identical elements.

### DETAILED DESCRIPTION

While the enclosures are described in the context of battery cells for electric vehicles, the enclosures can be used in stationary applications or other applications.

Charging/discharging cycles, aging of battery cells, and/or battery cell malfunctions (such as overheating and/or thermal runaway events) induce battery cell volume changes and/or internal pressure changes. In current enclosures for prismatic and/or cylindrical cells, bulging of larger side surfaces occurs in response to volume/pressure increases. Bulging may lead to heterogenous pressure distribution in the enclosure, which may cause non-uniform utilization of electrodes and/or electrode delamination.

An enclosure for prismatic and/or cylindrical battery cells according to the present disclosure enables guided expansion of an interior volume in response to cell expansion and/or vent gas pressure increases by facilitating deformation in structurally rigid areas and/or constraining deformation in areas that are prone to bulging. The enclosures according to the present disclosure promote more uniform deformation and, as a result, more homogenous internal pressure distribution. More homogenous pressure distribution improves battery service life and/or electrical performance.

An enclosure for prismatic and/or cylindrical battery cells according to the present disclosure enables guided contraction of an interior volume upon the application of external compression forces facilitating the uniform application of pressure to the electrodes during cell formation process.

In addition, some of the enclosures support additional functionality (e.g., battery cell interlocking and/or locating features, cooling features, etc.) into the enclosure. While the present disclosure is illustrated using prismatic battery cells as an example, the features can be used for other battery cell formats such as cylindrical or other types of battery cells.

Enclosures according to the present disclosure guide expansion due to battery cell swelling and/or vent gas pressure increases or guide contraction upon application of external pressure in predetermined ways to achieve uniform deformation and/or pressure distribution. In other words, the enclosures facilitate material elongations or compressions in some predetermined directions while restricting material deformation in other directions and/or limit localized deformation. In one approach, structurally rigid areas are directionally softened or weakened. For example, thinner material and/or less rigid material is strategically located in some portions/locations of the enclosure. In other examples, some portions/locations of the enclosure (e.g., edges, and/or corners of the enclosure) are strengthened or weakened using heat and/or ultrasonic vibration. In another approach, areas that are prone to bulging are stiffened (e.g., small or large sides of the enclosure).

Referring now to FIG. 1, a battery cell 10 includes C cathode electrodes 20, A anode electrodes 40, and S separators 32 arranged in a predetermined sequence in a battery cell stack 12 located in an enclosure 50. The C cathode electrodes 20-1, 20-2, . . . , and 20-C (where C is an integer greater than one) include cathode active layers 24 arranged on one or both sides of cathode current collectors 26. The A anode electrodes 40-1, 40-2, . . . , and 40-A (where A is an integer greater than one) include anode active layers 42 arranged on one or both sides of the anode current collectors 46. In some examples, the current collectors are made of one or more materials selected from a group consisting of copper, stainless steel, brass, bronze, zinc, aluminum, and/or alloys thereof. In some examples, external tabs connected to the current collectors of the anode electrodes and cathode electrodes are located on opposite sides of the battery stack (as shown in FIG. 1) or on the same side of the battery stack.

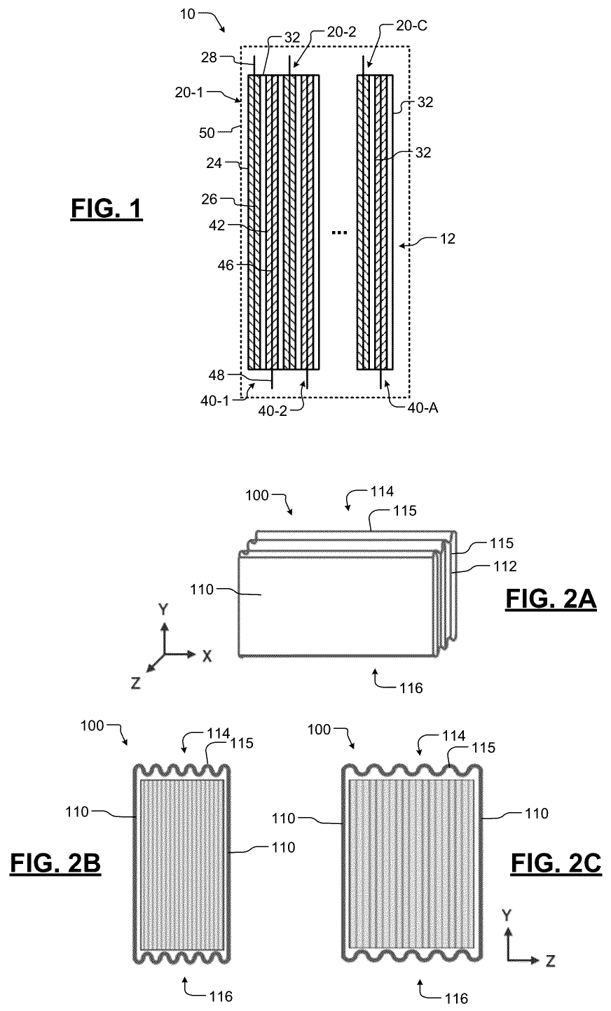

Referring now to FIGS. 2A to 2C, an enclosure 100 for a prismatic battery cell includes first side surfaces 110, second side surfaces 112, a top surface 114, and a bottom surface 116. In this example, the first side surfaces 110 correspond to the surfaces with the largest surface area and are arranged parallel to an x-y plane. The second side surfaces are arranged parallel to a y-z plane. The top surface 114 and the bottom surface 116 are arranged parallel to an x-z plane.

In this example, the top surface 114, the bottom surface 116, and the second side surfaces include corrugations 115. The corrugations 115 enable an accordion-like expansion or contraction in the z-axis direction to increase or decrease overall z-axis length (e.g., within the same width of the enclosure 100 in the x-and y-axis directions).

As battery cell swelling and/or internal gas pressure increases, the corrugations 115 along the second side surfaces 112, the top surface 114, and the bottom surface 116 flatten to accommodate expansion in the z-axis direction (compare FIGS. 2B and 2C), which reduces the bulging tendency of the large surfaces. The corrugations 115 increase stiffness of the side surfaces to resist bulging in y-axis direction.

Upon application of external compressive pressure to the enclosure, the corrugations 115 along the second side surfaces 113, the top surface 114, and the bottom surface 116 shorten to accommodate contraction in the z-axis direction.

In some examples, the enclosure 100 is made of metal. In some examples, the metal is selected from a group consisting of aluminum, aluminum alloy, steel, plated steel, stainless steel, high strength steel, and/or combinations thereof. Some metals such as aluminum alloy are strengthened by heating while other material such as high strength steel are weakened by heating. In some examples, expansion of the enclosure during normal charging and/or discharging or contraction of the enclosure during compression for cell formation does not exceed than the elastic properties of the materials used for the enclosure 100. In other words, the expansion or contraction is reversible. However, more significant thermal events associated with battery cell malfunction may exceed the elasticity of the materials of the enclosure.

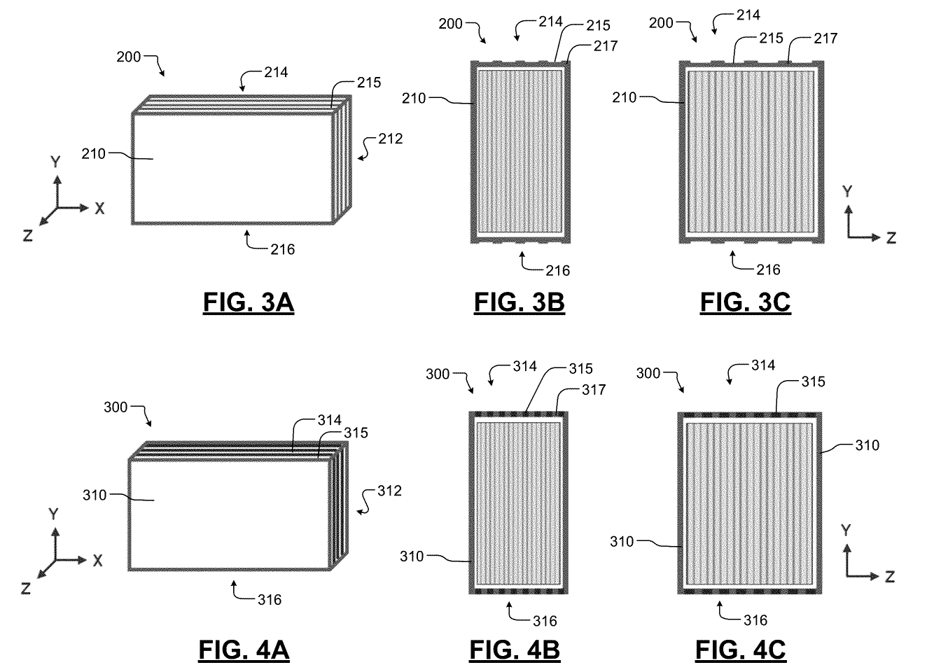

Referring now to FIGS. 3A to 4C, side surfaces of the enclosure are locally softened or hardened. The softening can be achieved by locally thinning the side surfaces to create a grooved structure via machining, laser ablation, or other approaches. In other examples, laser softening/hardening can be employed to locally modify and pattern mechanical properties of the side surfaces without introducing thickness variations. For example, heating using a heat source such as a laser or infrared heater and/or localized vibration such as ultrasonic vibration may be used.

In some examples, insulating layers and/or thermal interface materials are arranged between adjacent battery cells in a battery module and/or pack to contract and absorb some or all of the expansion. The insulating layers and/or thermal interface materials expand to fill volume when the battery cells contract.

In FIGS. 3A to 3C, an enclosure 200 for a prismatic battery cell includes first side surfaces 210, second side surfaces 212, a top surface 214, and a bottom surface 216. In this example, the top surface 214, the bottom surface 216, and the second side surfaces 212 include a plurality of grooves 215. The grooves 215 correspond to locations that are thinner and that are arranged between locations that are thicker (e.g. at 217).

The plurality of grooves 215 enable accordion-like expansion or contraction in the z-axis direction (e.g., while restricting expansion in the x-and y-axis directions). As swelling and/or internal gas pressure increases, the plurality of grooves 215 expand in the z-axis direction (compare FIGS. 3B and 3C), which reduces uncontrolled bulging of the large surfaces. Upon application of external compressive pressure, the plurality of grooves 215 shorten in the z-axis direction. The grooves 215 increase stiffness of the second side surfaces 212, the top surface 214, and the bottom surface 216 to resist bulging or other undesirable non-uniform deformation in the x-axis and/or y-axis directions.

In FIGS. 4A to 4C, an enclosure 300 for a prismatic battery cell includes first side surfaces 310, second side surfaces 312, a top surface 314, and a bottom surface 316. In this example, the top surface 314, the bottom surface 316, and the second side surfaces 312 include a plurality of portions 315 that are softened by heating using a laser relative to a plurality of portions 317 that are located adjacent thereto. When the plurality of portions 315 are laser softened (generally without changing material thickness), the plurality of portions 315 are able to expand (for example, compare FIGS. 4B and 4C) or contract more than the plurality of portions 317.

In other examples, the plurality of portions 315 are laser hardened relative to the plurality of portions 317 and the plurality of portions 317 expand and contract when bulging and/or internal pressure decrease. In some examples, the plurality of portions 315 and/or the plurality of portions 317 have a rectangular shape and extend from one side of the enclosure to the other side of the enclosure. In some examples, the plurality of portions 315 and the plurality of portions 317 alternate.

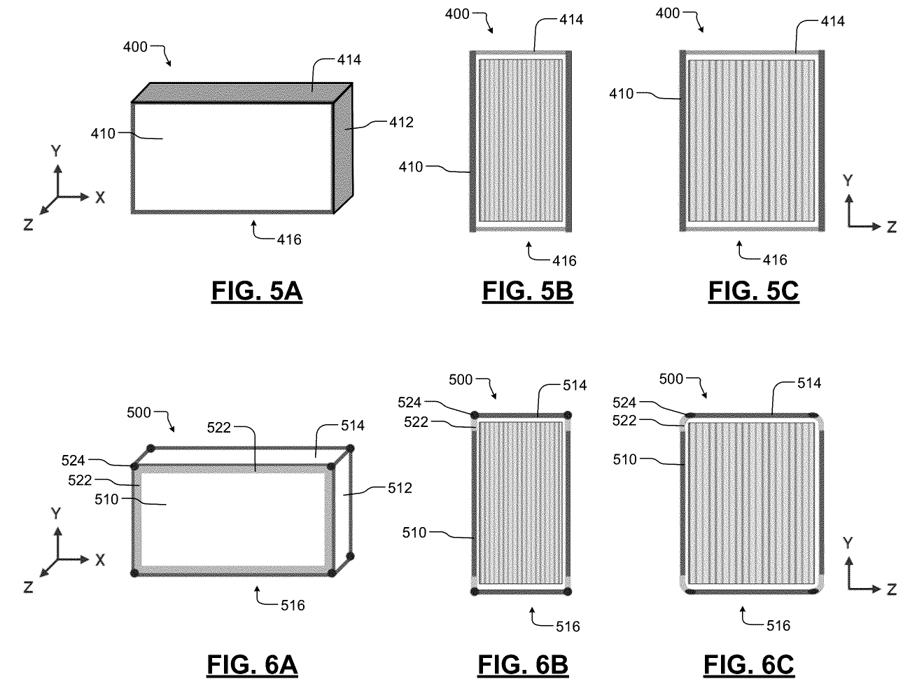

Referring now to FIGS. 5A to 6C, side surfaces are globally softened or weakened by using thinner gauge and/or lower strength materials and/or edges and/or corners are weakened using heat and/or vibration to facilitate more uniform expansion/deformation. As a result, the first side surfaces are able to elongate or shorten in z-axis direction (and to suppress the bulging or other undesirable non-uniform deformation of the larger side surfaces).

In FIGS. 5A to 5C, an enclosure 400 for a prismatic battery cell includes first side surfaces 410, second side surfaces 412, a top surface 414, and/or a bottom surface 416. In this example, the top surface 414, the bottom surface 416, and the second side surfaces 412 are globally weakened by using thinner gauge material (as compared to other portions of the enclosure) and/or using lower strength materials. The top surface 414, the bottom surface 416, and/or the second side surfaces 412 enable expansion/contraction in the z-axis direction (while limiting expansion/contraction in the x-and y-axis directions. As the internal/external pressure increases, the top surface 414, the bottom surface 416, and/or the second side surfaces 412 deform in the z-axis direction (compare FIGS. 5B and 5C), reducing the tendency of bulging or other undesirable non-uniform deformation of the large surfaces.

In FIGS. 6A to 6C, an enclosure 500 for a prismatic battery cell includes first side surfaces 510, second side surfaces 512, a top surface 514, and a bottom surface 516. In this example, edges 522 and/or corners 524 of the first side surfaces 510 (adjacent to second side surfaces 512, the top surface 514, and the bottom surface 516) are softened. As internal or external pressure increases, the edges 522 and the corners 524 expand (compare FIGS. 6B and 6C) or contract in the z-axis direction, reducing the tendency of bulging or other undesirable non-uniform deformation of the large surfaces.

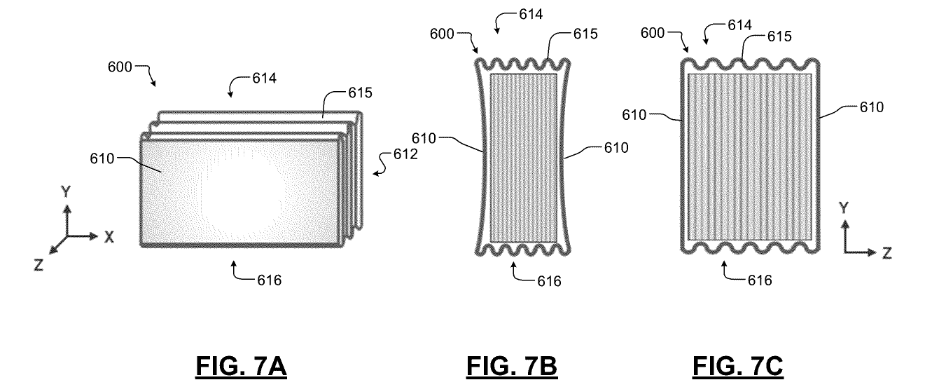

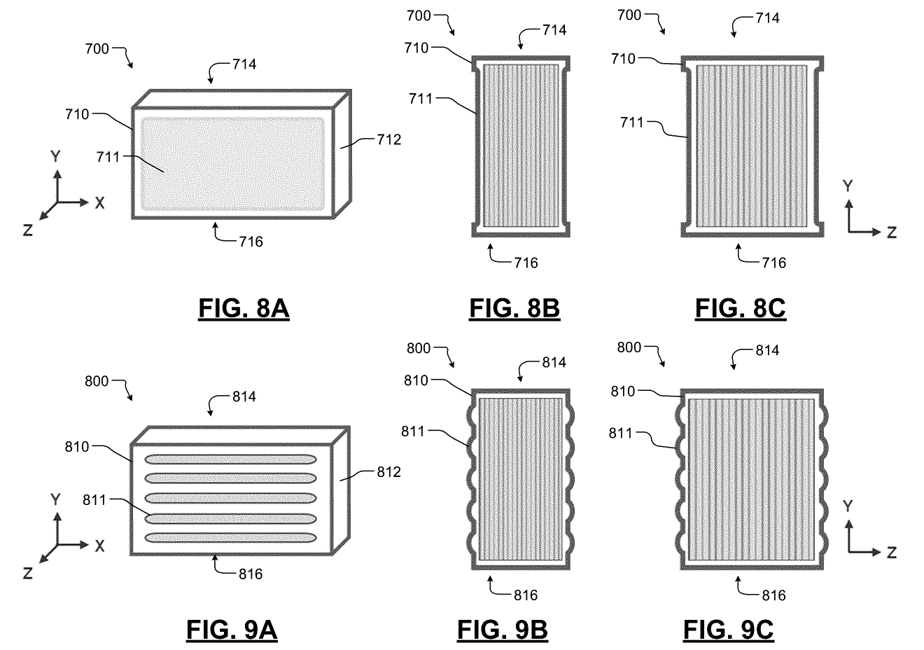

Referring now to FIGS. 7A to 7C, an enclosure include inward (or concave) curvature on the first side surfaces 610 to counteract the effect of bulging due to swelling and/or internal gas pressure. An enclosure 600 for a prismatic battery cell includes first side surfaces 610, second side surfaces 612, a top surface 614, and a bottom surface 616. In this example, the top surface 614, the bottom surface 616, and/or the second side surfaces 612 include corrugations 615. As described above and below, the corrugations 615 enable accordion-like expansion in the z-axis direction while limiting expansion the x-and y-axis directions. As swelling and/or internal pressure increases, the corrugations 615 flatten and curvature in the first side surfaces 610 straightens to accommodate expansion in the z-axis direction (compare FIGS. 2B and 2C), which reduces the bulging tendency of the first side surfaces. The corrugations 615 increase stiffness of the top surface 614, the bottom surface 616, and the second side surfaces 612 to resist bulging in x-axis and/or y-axis directions.

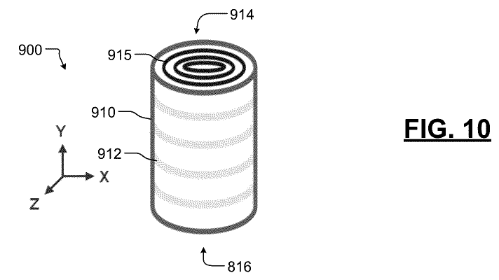

Referring now to FIGS. 8A to 9C, one or more stiffening features may be added to the first side surfaces (or the second side surface, top surface, and/or bottom surface) to resist bulging. In some examples, the stiffening features include but are not limited to offset surfaces and/or stiffening beads. The stiffening features can be formed in a direction towards or away from the battery cell stack. The orientation of the stiffening beads can vary (e.g., the stiffening beads extend in vertical, horizontal, or oblique directions). When combined with guided expansion/contraction features (such as corrugations, weakened portions, grooves, etc.) on the second side surface, the top surface, and/or the bottom surface, the enclosure controllably expands in a predetermined manner without bulging of the first side surface.

In FIGS. 8A to 8C, an enclosure 700 for a prismatic battery cell includes first side surfaces 710, second side surfaces 712, a top surface 714, and a bottom surface 716. In this example, the first side surface 710 includes an offset surface 711. In this example, the offset surface 711 extends inwardly and comprises greater than 50% of the area of the first side surfaces 710. The offset surface 711 increases the stiffness of the first side surface 710.

In FIGS. 9A to 9C, an enclosure 800 for a prismatic battery cell includes first side surfaces 810, second side surfaces 812, a top surface 814, and a bottom surface 816. In this example, the first side surface 810 includes stiffening beads 811. The stiffening beads 811 extend in an x-axis direction, y-axis direction or both x-axis and y-axis direction to stiffen the first side surface 810.

In FIG. 10, an enclosure 900 for a cylindrical battery is shown to include one or more stiffening features to stiffen cylindrical side surfaces, the top surface, and/or the bottom surface. The enclosure 900 includes a side surface 910 defining an open cylinder, a top surface 914 enclosing one end of the open cylinder, and a bottom surface 916 enclosing an opposite end of the cylinder. In some examples, the side surface 910 includes one or more annular stiffening beads 912 arranged parallel to the x-z plane and spaced from one another in the y-axis plane. In some examples, the top surface 914 and the bottom surface 916 include annular corrugations 915 that are arranged concentrically.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An enclosure for a prismatic battery cell, comprising:
first side surfaces;
second side surfaces connected between the first side surfaces;
a top surface connected between the first side surfaces and the second side surfaces; and
a bottom surface connected between the first side surfaces and the second side surfaces,
wherein the first side surfaces, the second side surfaces, the top surface and the bottom surface are configured to receive a battery cell stack, and
wherein the second side surfaces, the top surface and the bottom surface expand/contract to allow guided expansion/contraction of the enclosure in a first direction while limiting expansion in second and third directions transverse to the first direction.

2. The enclosure of claim 1, wherein the second side surfaces, the top surface, and the bottom surface comprise corrugations.

3. The enclosure of claim 1, wherein the second side surfaces, the top surface, and the bottom surface of the enclosure are made of a first material that is less stiff than a second material of the first side surfaces.

4. The enclosure of claim 1, wherein the second side surfaces, the top surface, and the bottom surface of the enclosure are made of a first material having a first thickness, wherein the first side surfaces are made of the first material and have a second thickness greater than the first thickness.

5. The enclosure of claim 1, wherein:
the second side surfaces, the top surface, and the bottom surface comprise first portions and second portions, and
the first portions are one of hardened and softened relative to the second portions.

6. The enclosure of claim 5, wherein the first portions of the second side surfaces, the top surface, and the bottom surface are one of hardened and softened using at least one of laser and infrared heating.

7. The enclosure of claim 5, wherein the first portions of the second side surfaces, the top surface, and the bottom surface are softened using ultrasonic vibration.

8. The enclosure of claim 2, wherein the first side surfaces are curved one of inwardly and outwardly.

9. The enclosure of claim 1, wherein:
the second side surfaces, the top surface, and the bottom surface comprise groove portions and non-grooved portions, wherein the grooved portions are thinner than the non-grooved portions.

10. The enclosure of claim 1, further comprising one or more strengthening beads arranged on the first side surfaces.

11. The enclosure of claim 1, further comprising an offset surface arranged on the first side surfaces, wherein the offset surface comprises more than 50% of an area of the first side surfaces.

12. The enclosure of claim 2, further comprising an offset surface arranged on the first side surfaces, wherein the offset surface comprises more than 50% of an area of the first side surfaces.

13. An enclosure for a prismatic battery cell, comprising:
first side surfaces;
second side surfaces connected between the first side surfaces;
a top surface connected between the first side surfaces and the second side surfaces; and
a bottom surface connected between the first side surfaces and the second side surfaces,
wherein the enclosure is configured to receive a battery cell stack,
wherein the first side surfaces include at least one of:
a plurality of stiffening beads; and
an offset surface comprising greater than 50% of an area of the first side surfaces,
wherein the second side surfaces, the top surface and the bottom surface expand to allow guided expansion/contraction of the enclosure in a first direction while limiting expansion in second and third directions transverse to the first direction.

14. The enclosure of claim 13, wherein the second side surfaces, the top surface, and the bottom surface comprise corrugations.

15. The enclosure of claim 13, wherein the second side surfaces, the top surface, and the bottom surface of the enclosure are made of a first material that is less stiff than a second material of the first side surfaces.

16. The enclosure of claim 13, wherein the second side surfaces, the top surface, and the bottom surface of the enclosure are made of a first material having a first thickness, wherein the first side surfaces are made of the first material and have a second thickness greater than the first thickness.

17. The enclosure of claim 13, wherein:
the second side surfaces, the top surface, and the bottom surface comprise first portions and second portions, and
the first portions are one of hardened and softened relative to the second portions using at least one of laser heating, infrared heating, and ultrasonic vibration.

18. The enclosure of claim 13, wherein the first side surfaces are curved one of inwardly and outwardly.

19. The enclosure of claim 13, wherein:
the second side surfaces, the top surface, and the bottom surface comprise groove portions and non-grooved portions, wherein the grooved portions are thinner than the non-grooved portions.

20. The enclosure of claim 13, further comprising one or more strengthening beads arranged on the first side surfaces.
